(19) United States
(12) Patent Application Publication
(10) Pub. No.: US 2013/0161087 A1
(43) Pub. Date: Jun. 27, 2013

(54) SOLDER BALL DEVICE, HOUSING HAVING A SOLDER BALL DEVICE AND PRODUCTION PROCESS FOR A SOLDER BALL DEVICE

(71) Applicant: Robert ROJAHN, Tuebingen (DE)

(72) Inventor: Robert ROJAHN, Tuebingen (DE)

(21) Appl. No.: 13/720,264

(22) Filed: Dec. 19, 2012

(30) Foreign Application Priority Data
Dec. 22, 2011 (DE) 10 2011 089 550.7

(51) Int. Cl. H01B 1/20; H01B 13/30

(52) U.S. Cl. CPC H01B 1/20; H01B 13/30
USPC 174/541; 174/126.2; 228/203

(57) ABSTRACT

A solder ball device has a contact surface and a solder ball that is connected electrically conductively to the contact surface. Between the solder ball and the contact surface, a conductive polymer is situated, which is connected to the solder ball and the contact surface.

### BACKGROUND OF THE INVENTION

1. Field of the Invention

The present invention relates to a solder ball device, a housing having a solder ball device, as well as a production method for a solder ball device.

2. Description of the Related Art

Housings having solder ball devices (also known as ball grid arrays, “BGA”) have been used for a long time as packaging for electronic circuits. In this context, according to the standard, the Si circuits (ASIC, etc.) are adhered to an epoxy laminate and are wire-bonded. The laminate is comparable to a very thin printed-circuit board. Besides the mechanical fixing of the Si circuits, it also produces the electrical connections between the wire bonds of the Si circuits and the contact surfaces on the underside of the laminate. As protection from external influences, and for improved further processing, the Si circuits including the wire bonds are encased by extrusion, the laminate continuing to provide the underside of the BGA. Finally, solder balls are applied to the underside of the laminate onto contact surfaces provided for this. The BGA produced in this manner may be assembled on printed-circuit boards and soldered in a standard reflow soldering method. The bigger the BGA, the more mechanical stresses between the BGA and the printed-circuit board limit the service life of the BGA. In particular, but not only, the different thermal expansion coefficients of the BGA and the printed-circuit board cause mechanical tensions in response to temperature changes, which may, for instance, allow the soldering connection, usually the solder balls, to crack. As large a distance as possible between the printed-circuit board and the BGA is able to increase the elasticity of the BGA-printed-circuit board system and improve the resistance to temperature changes. Large balls, but also cylinder-shaped spacers between the contact surfaces of the laminate underside and the balls enlarge the distance apart, as is described in the document, Integrated Circuit Engineering Corporation, Chap. 10, Grid Array Packaging: BGA and CSP., FIG. 10-52.

Microelectromechanical devices and Systems (MEMS) such as acceleration sensors, yaw sensors, pressure sensors or microphones are packaged in the housing. Suitable housings not only have to ensure the external electrical contacting of the MEMS, but also protect the MEMS from mechanical tensions and other environmental influences. In order to maintain the size advantages of the micromechanical device, the housing should be designed as compact as possible, in this instance.

### BRIEF SUMMARY OF THE INVENTION

An objective of the present invention is the reduction in the mechanical stresses on the soldered connection of the BGA and on the circuit components on the inside.

The present invention starts from a solder ball device having a contact surface and having a solder ball that is connected electrically conductively to the contact surface. The crux of the invention is that, between the solder ball and the contact surface, a conductive polymer is situated, which is connected to the solder ball and the contact surface. Because of its electrical property, the conductive polymer advantageously lowers the transmission of mechanical stresses between the solder ball and the contact surface.

However, a metallic intermediate layer is advantageously situated between the solder ball and the conductive polymer. The metallic intermediate layer effects a better adhesion promotion between the solder ball and the conductive polymer. However, a metallic intermediate layer is also advantageously situated between the conductive polymer and the contact surface. The metallic intermediate layer effects a better adhesion promotion between the conductive polymer and the contact surface.

The present invention also relates to a housing having a solder ball device, a so-called BGA. Because of its elasticity property, the conductive polymer advantageously lowers the transmission of mechanical stresses between the solder ball and the inside of the housing. Thus, electric or micromechanical devices are advantageously able to be packaged in the inside of the housing and, at the same time, be protected from mechanical stresses. In particular, these devices are able to be contacted electrically outwards and be protected simultaneously from mechanical stresses which, for example, are transmitted by a printed-circuit board, on which the BGA is mounted, to the solder balls of the BGA.

Whereas up to now, BGA in the related art have been connecting the circuit on the inside with the printed-circuit board via a hard metallic connection, the present invention provides the introduction of an intermediate layer of an elastic, conductive polymer. For example, an epoxy filled with silver (Ag) flakes could be used as an electric, conductive elastic polymer. Based on its greater elasticity, the conductive polymer is better able to compensate for motions of the printed-circuit board and of the BGA, so that lower mechanical stresses act, for one thing, on the solder connection, and for another, on the BGA inside. With that, the reliability at the level of the printed circuit board and the solder balls (English: board level reliability, BLR) is improved and negative effects of mechanical stresses on the electric characteristics curves of the MEMS Si circuits in the BGA are reduced.

The present invention also relates to a method for producing a solder ball device, having the method steps:
(A) providing a laminate having a metallic contact surface
(B) applying a conductive polymer
(C) applying a solder ball

One advantageous embodiment of the method according to the present invention provides that, after step (A) and before step (B), in a step (D), a metallic intermediate layer is applied for adhesion promotion between the contact surface and the conductive polymer.

One advantageous embodiment of the method according to the present invention provides that, after step (A) and before step (B), in a step (D), a metallic intermediate layer is applied for adhesion promotion between the contact surface and the conductive polymer.

### BRIEF DESCRIPTION OF THE DRAWINGS

FIG. 1 shows the solder ball device of the related art.

FIG. 2 shows a solder ball device according to the present invention.

### DETAILED DESCRIPTION OF THE INVENTION

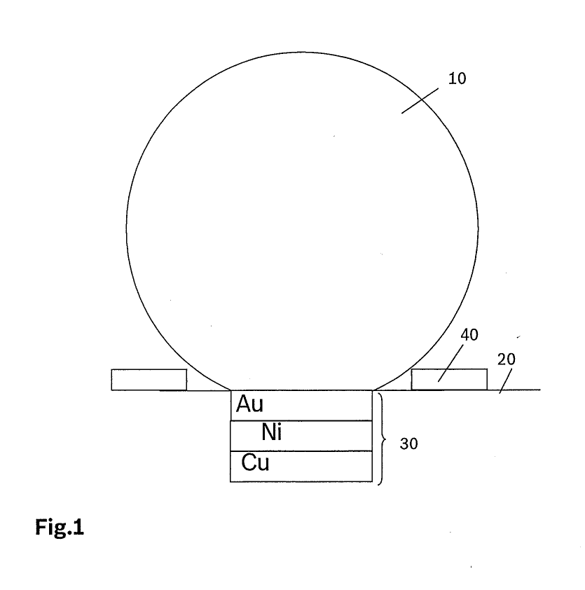

FIG. 1 shows the solder ball device of the related art. A cutout of a BGA is shown schematically having a laminate 20 that has a contact surface 30, and having a solder ball 10, which is situated on contact surface 30 in an electrically contacting manner. Contact surface 30 is a metallic contact surface and, in this exemplary embodiment, has a sequence of metallic layers of copper (Cu), nickel (Ni) and gold (Au), the solder ball being connected to the gold layer. Solder ball 10 is composed, for example, of SnAgCu or SnPb. The planar extension of the connection of solder ball 10 to BGA 20 is bordered either by a mask made of solder stop lacquer 40 (“solder mask defined”), or such a mechanical contact is specifically avoided (non-solder mask defined”).

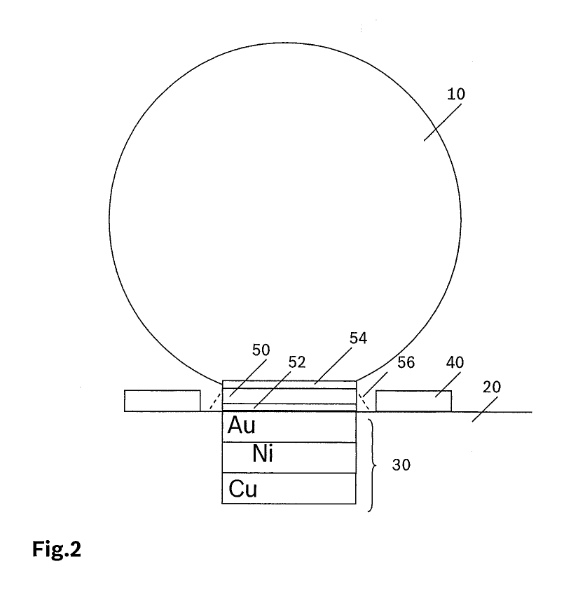

FIG. 2 shows a solder ball device according to the present invention. In contrast to the related art, an electric, conductive polymer 50 is situated between solder ball 10 and contact surface 30. An epoxy filled with silver (Ag) flakes is situated as the conductive polymer, for example. Other conductive polymers having sufficient adhesion capability or even suitable elasticity may equally be used.

The subject matter of the present invention is also a method for producing a solder ball device according to the present invention. The method has the following method steps:
(A) providing a laminate 20 having a metallic contact surface 30.
(B) applying a conductive polymer 50
(C) applying a solder ball 10

Polymer 50 is applied, using a suitable method, to contact surface 30. The application takes place, for example, by stamp printing or screen printing, comparable to applying soldering paste on a printed-circuit board for reflow soldering, jet dispensing, or the like. Depending on the application method, the polymer may have sides 56, as a result, which run out in the direction of the soldering stop lacquer.

To improve the adhesion of polymer 50 to contact surface 30, a metallic intermediate layer 52 may be necessary, made of nickel (Ni), for instance. Intermediate layer 52 is applied to contact surface 30 after step (A) and before step (B), in optional step (D).

After conductive polymer 50, there follows optionally a metallic intermediate layer 54, for instance, a Ni layer for the improved adhesion of solder ball 10 to it. Alternatively, a Ni/Sn layer 54 or a Ni/Au layer 54 is provided. Intermediate layer 54 is applied to polymer 50 after step (B) and before step (C), in optional step (E).

Subsequently there follows the balling process (fluxing material, balling, fusion) for applying solder ball 10 in step (C).

The solder ball device according to the present invention has an installation height, increased essentially by the layer thickness of conductive polymer 50, with respect to a solder ball device in the related art. As a result, the standoff of a BGA housing, which has the solder ball device according to the present invention, from a printed-circuit board situated on it is essentially increased by the layer thickness of the conductive polymer 50. The elastic polymer reduces mechanical stresses, which are able to be transmitted from the outside, for example, by a printed-circuit board via the solder balls onto the contact surface or the housing (e.g. the BGA), as described in the section Advantages of the Invention. The conductivity of the polymer ensures the electric contacting of the BGA to the printed-circuit board.

The subject matter of the present invention is also a housing having a solder ball device according to the present invention, or a plurality of solder ball devices, particularly a so-called BGA housing. For this, the housing has an outer side of the laminate 20 and on this, one or a plurality of solder ball devices according to the present invention. The BGA housing according to the present invention is particularly suitable for micromechanical devices (MEMS), because it transmits fewer mechanical stresses to the inside than BGA housings of the related art.

What is claimed is:

1. A solder ball device, comprising:
a contact surface;
a solder ball; and
a conductive polymer situated between the solder ball and the contact surface, wherein the conductive polymer is connected to the solder ball and the contact surface, whereby the solder ball is connected electrically conductively to the contact surface.

2. The solder ball device as recited in claim 1, wherein at least one of: (i) between the solder ball and the conductive polymer, a metallic intermediate layer is provided; and (ii) between the conductive polymer and the contact surface, a metallic intermediate layer is provided.

3. A housing system for packaging a microelectromechanical device, comprising:
a housing: and
a solder ball device provided on the housing, wherein the solder ball device has a contact surface, a solder ball, and a conductive polymer situated between the solder ball and the contact surface, wherein the conductive polymer is connected to the solder ball and the contact surface, whereby the solder ball is connected electrically conductively to the contact surface.

4. A method for producing a solder ball device, comprising:
(a) providing a laminate having a metallic contact surface;
(b) applying a conductive polymer to the metallic contact surface; and
(c) subsequently applying a solder ball to the conductive polymer.

5. The method as recited in claim 4, wherein after step (a) and before step (b), applying a metallic intermediate layer to facilitate adhesion between the metallic contact surface and the conductive polymer.

6. The method as recited in claim 4, wherein after step (b) and before step (c), applying a metallic intermediate layer to facilitate adhesion between the conductive polymer and the solder ball.
